(19) United States
(12) Patent Application Publication
(10) Pub. No.: US 2023/0343060 A1
(43) Pub. Date: Oct. 26, 2023

(54) METHOD FOR NON-CONTACT TRIGGERING OF BUTTONS

(71) Applicant: NATIONAL TSING HUA UNIVERSITY, Hsinchu City (TW)

(72) Inventors: Hung-Wen CHEN, Hsinchu City (TW); Yi-Jiun SHEN, Taoyuan City (TW); Chen-Wei HU, Kaohsiung City (TW)

(73) Assignee: NATIONAL TSING HUA UNIVERSITY, Hsinchu City (TW)

(21) Appl. No.: 18/098,953

(22) Filed: Jan. 19, 2023

(30) Foreign Application Priority Data
Apr. 20, 2022 (TW) 111115086

(51) Int. Cl. G06V 10/147; B66B 1/14; G06F 3/01; G06V 10/82; G06V 10/80

(52) U.S. Cl. CPC G06V 10/147; B66B 1/14; G06F 3/017; G06V 10/82; G06V 10/809

(57) ABSTRACT

Disclosed are techniques for elevator control. In an aspect, a sensor senses time series data, wherein the time series data includes at least one image, and range of the image covers a plurality of buttons. A system module configured to determine whether the image contains a target object; determine a tip coordinate of a tip of the target object when the image contains the target object, wherein the tip refers to a point of the target object with the closest distance to the operation panel; and determine button information corresponding to the tip coordinate among a plurality of button information, and transmit a control signal at least according to the button information, wherein the plurality of button information is associated with the plurality of buttons. A controller receives the control signal and perform control operation according to the control signal.

### BACKGROUND OF THE INVENTION

### 1. Field of the Invention

Aspects of the disclosure relate to the technical field of elevator control. Specifically, the aspects of the disclosure relate to a non-contact buttons triggering method.

### 2. Description of the Prior Art

The operation and contact with public equipment in daily life can cause the spread of viruses and bacteria, causing a risk of disease. Some places, such as apartments, business buildings, and even hospitals or clinics, are more likely to be high risk because of their high pedestrian flow and the irregularity of people's access. The buttons of the elevators in these places are easily to be a breeding ground for viruses regardless of whether the users touch the buttons with fingers or other items (e.g., keys).

In order to avoid direct contact between users and buttons, the current methods can be roughly divided into two types. One is to maintain physical contact, but increase the frequency of disinfection or attach a disinfection film to the buttons. The other is to operate the elevator in a non-contact way. For example, triggering the elevator buttons by voice control or infrared rays, etc. However, the former way may not achieve the purpose of effectively preventing the spread of viruses since the frequency of disinfection is much lower than the usage rate, and the disinfection film still requires a functioning time. While the latter way can completely avoid touching the elevator buttons, the operation of the voice control may be disturbed by the ambient noise, and the operation of infrared rays may be affected by the ambient humidity. Therefore, there is currently a need for an elevator button triggering method that can effectively prevent the spread of viruses while taking into account the accuracy and ease of use.

### SUMMARY OF THE INVENTION

It is an object of the present invention to provide a non-contact elevator button triggering method through a 3D camera, which can prevent personnel from touching the elevator buttons, thereby effectively preventing the spread of viruses through the buttons.

It is an object of the present invention to provide a non-contact elevator button triggering method through a 3D camera, which can reduce the misjudgment rate of non-contact button triggering, thereby improving its usage efficiency.

It is an object of the present invention to provide a non-contact elevator button triggering method through a 3D camera, which can be simply applied to the existing elevator operation panel, thereby improving the convenience of its application.

It is an object of the present invention to provide a non-contact elevator button triggering method through a 3D camera, which can achieve non-contact button triggering while the user maintains the original operating habits.

In an embodiment, a non-contact button triggering method includes: sensing time series data with a sensor arranged on an operation panel, wherein the time series data includes at least one image, and the range of the image covers a plurality of buttons arranged on the operation panel; determining whether the image contains a target object by a system module; determining a tip coordinate of a tip of the target object by the system module when the image contains the target object, wherein the tip refers to a point of the target object with the closest distance to the operation panel; determining button information corresponding to the tip coordinate among a plurality of button information by the system module, and transmitting a control signal at least according to the button information, wherein the plurality of button information is associated with the plurality of buttons; and receiving the control signal by a controller, and performing control operation according to the control signal.

With this configuration, the elevator buttons can be triggered before the user presses the button to achieve the purpose of the present invention by triggering the buttons in a non-contact manner without additionally teaching the user the method of operation or changing the user's operation habit.

### BRIEF DESCRIPTION OF THE APPENDED DRAWINGS

FIG. 1 is a flowchart of the non-contact button triggering method according to an embodiment of the present invention.

FIG. 2 is a schematic diagram of the system applying the non-contact button triggering method according to an embodiment of the present invention.

FIG. 3 is a schematic diagram of images of time series data according to an embodiment of the present invention.

FIG. 4 is a schematic diagram of the operation of the machine learning model according to an embodiment of the present invention.

FIG. 5A to FIG. 5E are schematic diagrams of training sets of the machine learning model according to an embodiment of the present invention.

FIG. 6 is a schematic diagram of determining the tip according to an embodiment of the present invention.

FIG. 7 is a schematic diagram of the structure of the machine learning model according to an embodiment of the present invention.

FIG. 8A is a schematic diagram of the lookup table for button information according to an embodiment of the present invention.

FIG. 8B is a schematic diagram of determining the button information according to an embodiment of the present invention.

FIG. 9 is a flow chart of enabling/disabling the first mode according to another embodiment of the present invention.

FIG. 10 is a schematic diagram of the operation of the machine learning model according to another embodiment of the present invention.

FIG. 11A and FIG. 11B are schematic diagrams of the threshold range for determining the tip according to another embodiment of the present invention.

### DETAILED DESCRIPTION OF THE INVENTION

The following describes the method for the non-contact triggering of buttons of the present invention through the embodiments and drawings, and those skilled in the art can understand the technology and effect of the present invention with the present disclosure. However, the content disclosed below is not intended to limit the scope of the claimed subject matter. Without departing from the spirit of the present invention, those ordinarily skilled in the art can implement the present disclosure with embodiments with different structures and operating order.

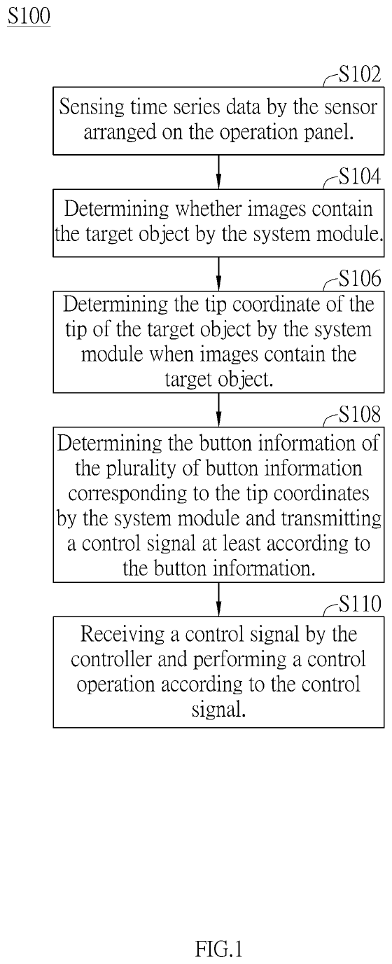

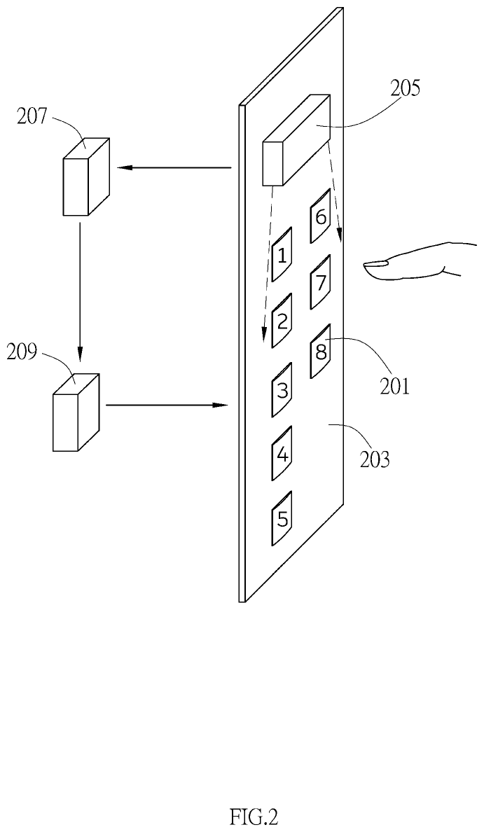

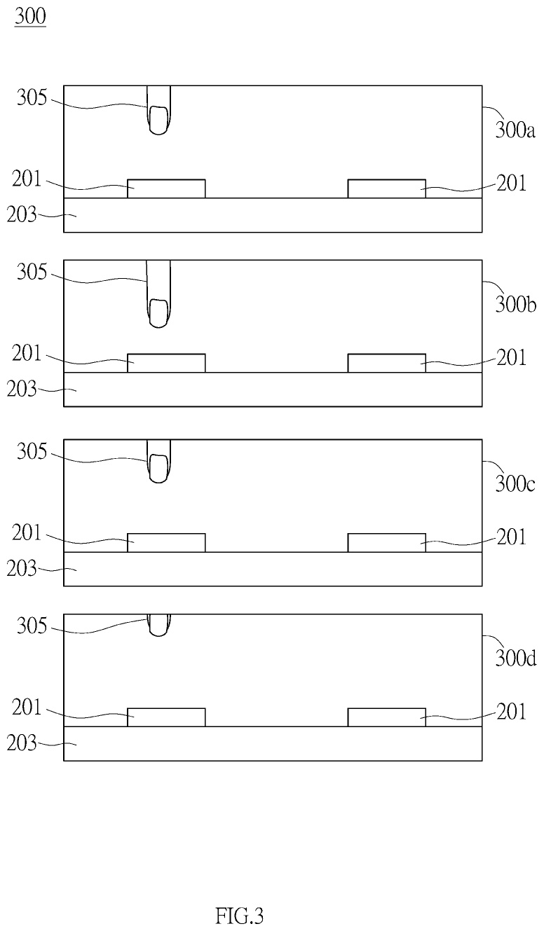

Referring to FIG. 1, FIG. 2, and FIG. 3, an embodiment of the method for non-contact triggering of buttons S100 of the present invention is illustrated. At block S102, the method includes sensing time series data by the sensor 205 arranged on the operation panel 203, wherein the time series data includes at least one image 300, and the range of the image 300 covers the plurality of buttons 201 arranged on the operation panel 203. Referring to FIG. 2, FIG. 2 shows a schematic diagram of a non-contact elevator button triggering system for implementing the method. In this embodiment, the sensor 205 is arranged on the operation panel 203 at a position higher than the plurality of buttons 201 and is electrically coupled to the system module 207. The system module 207 is electrically connected to a controller 209, wherein the controller 209 is also electrically connected to the plurality of buttons 201. In this embodiment, the sensor 205 is a 3D sensor (e.g., a 3D camera), so the time series data sensed by the sensor 205 includes a plurality of images 300 captured at a certain time interval (e.g., 0.1 second) and the depth information of all the objects within the sensing range, wherein the range of the images 300 (the sensing range of the sensor 205 is shown with the dotted arrow in FIG. 2) covers the buttons 201 located below it, and in this embodiment, does not cover the user's face to protect the user's privacy.

Referring to the schematic diagram of images 300 in FIG. 3, the images 300a, 300b, 300c, and 300d in FIG. 3 are the images 300 respectively captured at a time interval, and respectively contain the moving fingers 305. It should be noted that the range of the images 300 covering the buttons 201 means that the width and length of images 300 are greater than the area where the buttons 201 are arranged, and it is not intended to capture the buttons 201 themselves (as shown in FIG. 3, the upper button 201 hid the other buttons 201 below in the images 300 so that only the upper button can be seen in the image. Or in different facilities, the buttons 201 do not protrude from the operation panel 203, so there isn't any button that can be seen in the image, and the present invention is not limited thereto).

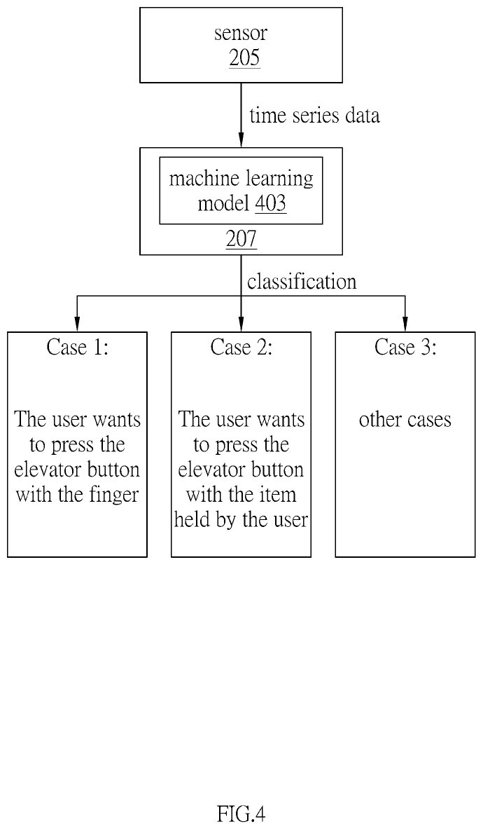

Referring to FIG. 4, an embodiment of the method for non-contact triggering of buttons S100 of the present invention is continued. At block S104, the method includes determining whether images 300 contain the target object by the system module 207. In detail, after receiving the time series data sensed by the sensor 205, the system module 207 uses the machine learning model 403 to identify the objects contained in the images 300 to generate a classification result. The classification result includes at least three types. The first case is that the machine learning model 403 identified from the images 300 that the user wants to press the elevator button with his/her finger. The second case is that the machine learning model 403 identified from the images 300 that the user wants to press the elevator button with the item (such as a key) held by the user. The third case is other cases. Among them, according to the classification results of the first and second cases, it is determined that the object is the target object (that is, the images 300 contain the target object), and according to the classification result of the third case, it is determined that the object is not the target object (that is, the images 300 do not contain the target object).

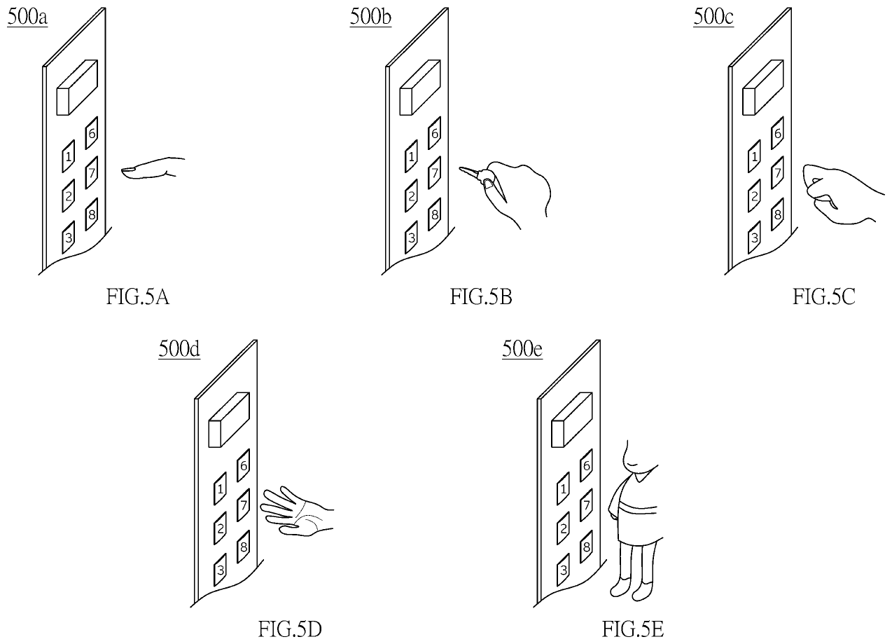

Referring to FIGS. 5A to 5E, an embodiment of the machine learning model 403 of the present invention is illustrated. FIGS. 5A-5E include schematic diagrams of pre-processed labeled training images 500a, 500b, 500c, 500d, and 500e. The machine learning model 403 is trained with the labeled training images 500a-500e as a training set. The images 300 sensed by the sensor 205 may be pre-processed to form the labeled training images 500a-500e, or other existing images may also be pre-processed to form them, and the present invention is not limited thereto. The pre-processing includes labeling the tag for the image. In this embodiment, the types of the tags include the user pressing the elevator button with his/her finger (i.e., case 1), the user pressing the elevator button with an item in his/her hand (i.e., case 2), and other cases (i.e., case 3). Referring to the schematic diagrams of the labeled training images 500a-500e in FIGS. 5A to 5E, the labeled training image 500a includes pressing a button with a finger, so it should be labeled as case 1. The labeled training image 500b includes pressing a button with a hand-held item, so it should be labeled as case 2. The labeled training image 500c includes pressing the button with the knuckle, so it should be labeled as case 1. In this embodiment, other cases (i.e., case 3) include various situations in which the user does not intend to press the elevator buttons. For example, in the labeled training image 500d, the user's palm facing upward should be determined as not intending to press the buttons, so it should be labeled as case 3; in the labeled training image 500e, the user is too close to the operation panel 203 such that the shoulder (hair, backpack) is accidentally captured in the image, and it should be determined that the user does not intend to press the buttons, so it should be labeled as case 3. By inputting a large number of labeled training images (e.g., the labeled training images 500a-500e) into the machine learning model 403, the machine learning model 403 can learn to classify the images 300, and thereby determine whether the images 300 contain the target object (determining that the images 300 contains the target object according to classification result of case 1 or case 2 and determining that the target object is not contained in images 300 according to the classification result of case 3).

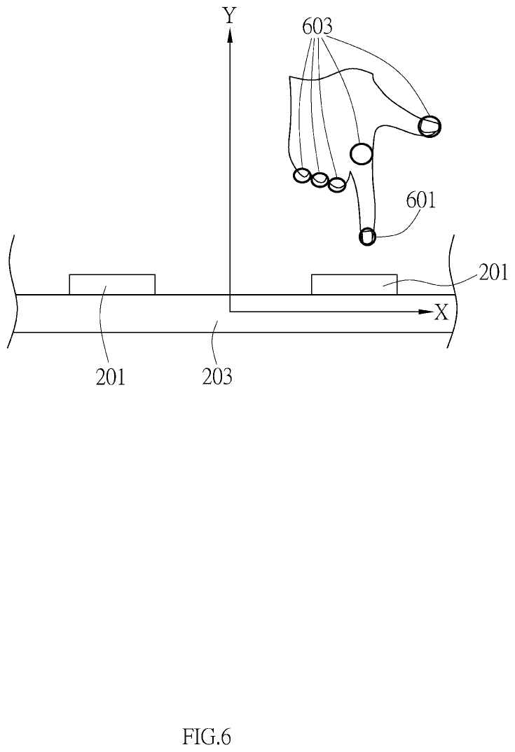

Referring to FIG. 6, an embodiment of the method for non-contact triggering of buttons S100 of the present invention is continued. At block S106, the method includes, when the images 300 contain the target object, determining the tip coordinate of the tip 601 of the target object by the system module 207, wherein the tip 601 refers to a point of the target object with the closest distance to the operation panel 203. Referring to FIG. 6, in detail, the system module 207 can identify a plurality of protruding points 603 (such as fingertips, knuckles, or the tip of a key, etc.) of the target object, determine the two-dimensional coordinates (x, y) of these protruding points 603, respectively, and determine one of the protruding points 603 with the closest distance to the operation panel 203 to be the tip 601. In this embodiment, the two-dimensional coordinate system of the protruding point 603 takes the sensor 205 as the origin, takes the horizontal axis as the X axis, and takes the vertical axis as the Y axis, wherein the distance between the protruding point 603 and the operation panel 203 is calculated by the method of comparing the values of the Y-axis (the larger the value of the Y-axis, the farther away from the operation panel 203). It should be noted that, in different embodiments, the distance between the protruding point 603 and the operation panel 203 can also be calculated in other ways (e.g., calculating both the values of the X-axis and the Y-axis), and the present invention is not limited thereto. After the system module 207 determines the tip 601 from the protruding points 603, the two-dimensional coordinates of tip 601 are combined with the depth information sensed by the sensor 205 to generate three-dimensional tip coordinates (x, y, z).

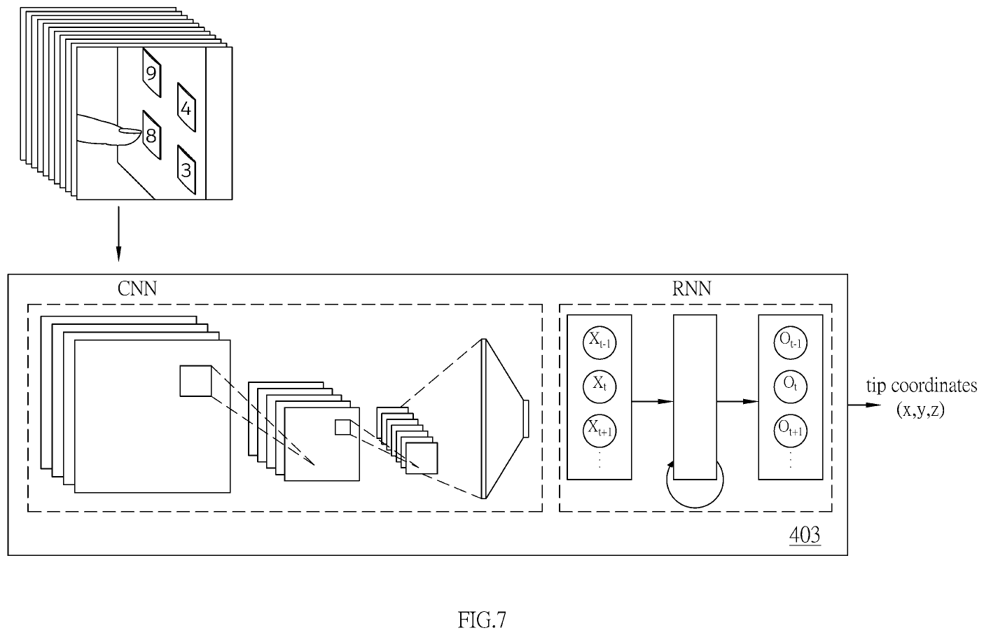

In this embodiment, determining the tip coordinates of the tip 601 of the target object includes using machine learning technology (wherein identifying the protruding points 603 (e.g., fingertips, knuckles) of the target object by the machine learning technology is a well-known technology for those skilled in the art, and thus it will not be described in detail here), and the machine learning technology can be integrated into the machine learning model 403 mentioned above. For example, referring to FIG. 7, the machine learning model 403 may use Convolutional Neural Networks (CNN) and Recurrent Neural Networks (RNN), wherein the images 300 sensed by the sensor 205 can be used as an input to obtain the coordinates of the tip of the target object after the processes mentioned above such as determining the target object and determining the tip 601, in cooperation with the depth information sensed by the sensor 205. It should be noted that although the 2D images 300 are input into the machine learning model 403 to obtain the tip coordinates in this embodiment, in different embodiments, traditional image processing techniques other than machine learning (such as skin color recognition, contour extraction, etc.) can also be used to obtain the tip coordinates of the target object, or a data format other than 2D data (such as point cloud data) can be used as input, and the present invention is not limited thereto.

It should be noted that although there is only one target object shown in this embodiment, in different embodiments, the images 300 may include multiple target objects at the same time (for example, multiple people want to press the elevator buttons 201), and the present invention does not limit this.

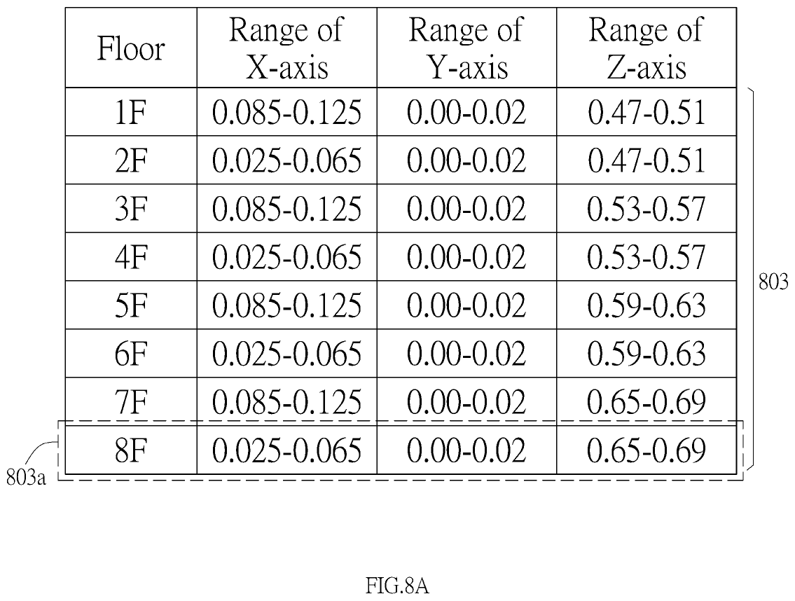

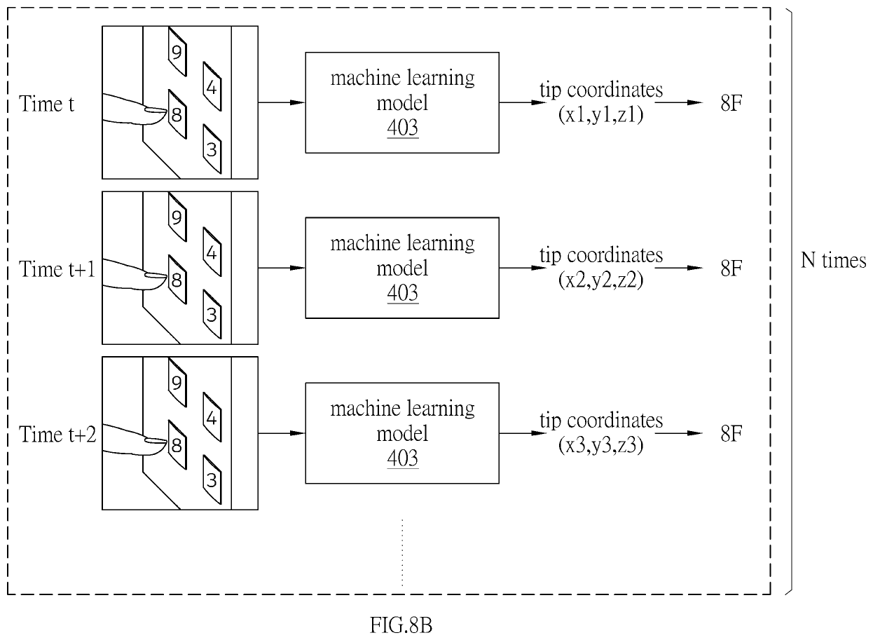

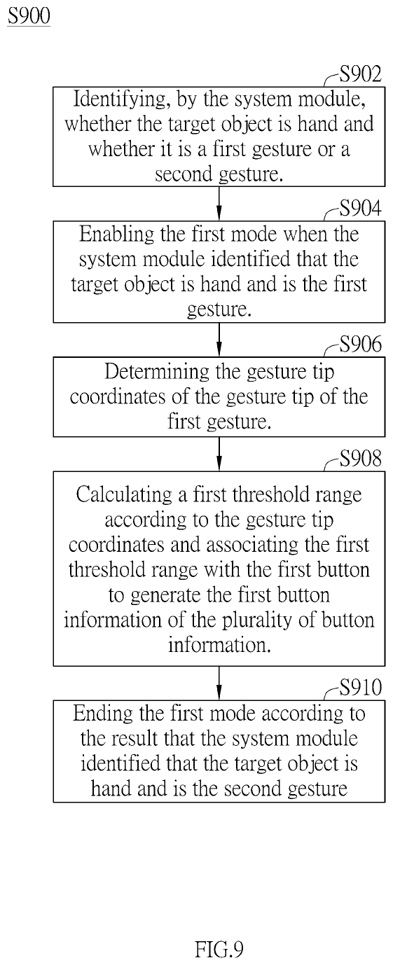

Referring to FIG. 8A, an embodiment of the method for non-contact triggering of buttons S100 of the present invention is continued. At block S108, the method includes determining the button information 803a of the plurality of button information 803 corresponding to the tip coordinates by the system module 207 and transmitting a control signal at least according to the button information 803a, wherein the plurality of button information 803 is associated with the buttons 201. Referring to FIG. 8A, each of the plurality of button information 803 is associated with a specific button 201 (floor) and indicates the threshold range of a specific three-dimensional coordinate. For example, the button information 803a corresponds to the eighth floor (8F) and indicates the X-axis coordinate range of 0.025-0.065 m, the Y-axis coordinate range of 0.00-0.02 m, and the Z-axis coordinate range of 0.65-0.69 m. The system module 207 obtains the tip coordinates (e.g., (0.047, 0.01, 0.68)) and compares them with the plurality of button information 803 (e.g., through a look-up table). According to the comparison result that the tip coordinates are between the coordinate threshold range (0.025-0.065, 0.00-0.02, 0.65-0.69) indicated by the button information 803a, the system module 207 determined that the tip coordinate corresponds to the button information 803a. It should be noted that the button information 803 can be a specific default three-dimensional coordinate threshold range, or the user can register different coordinate threshold ranges for different arrangements of buttons 201 (referring to the description of FIG. 9 below for details). The present invention does not limit this.

Referring to FIG. 8B, the block S108 is continued. According to the time series data sensed by the sensor in a certain time interval (for example, 0.1 second), the system module 207 will continuously determine the corresponding button information 803 according to the tip coordinate, and each time the determined button information 803 will get a score. During a specific calculation period, the system module 207 will transmit a control signal of the floor corresponding to the button information 803 with the highest score, with the score reaching the threshold, or with the score reaching the threshold and the highest score at the same time (for example, the button information 803 corresponds to 8F, and thus the system module 207 indicates the control signal of going to 8F). For example, the score obtained by the button information 803 each time may be a function f, where the function f is a function of time t and the tip coordinates (x, y, z). During a specific calculation period (e.g., the number of determinations N=15), the score of each determined button information 803 is calculated; that is, the total score of the button information 803 is Σₙ₌₀^{N-1} f(t+n, (xₙ, yₙ, zₙ)). With this configuration, the score of the button information 803 can be associated with the time sequence of different frames and the distance of the tip coordinates. For example, if the function f is 1/N−n, then the button information 803 determined at time t+0 gets a score 1/15; the button information 803 determined at time t+1 gets a score 1/14, and so on. With this configuration, the button information 803 determined closer to the current time will get a higher score. It should be noted that the aforementioned function f is only an exemplary illustration, and the user can design a suitable function f based on experience (for example, f can be 1/(zₙ−zₒ), wherein z₀ is the value of the Z-axis of the center coordinate of the surface of the button, and the score will be higher when the determined tip coordinate is closer to the surface of the button). The present invention does not limit this.

In addition to taking the number of determinations as the calculation period, the system module 207 can generate a control signal when the score of one of the button information 803 reaches the threshold k, after that, end the calculation period and reset all the scores to zero. For example, the score S of the button information 803 can be calculated by the following formula:

S_{new frame}^{F}=S_{old frame}^{F}*α+γ

Among them, F is the floor corresponding to the currently determined button information 803, α is the memory weight, and γ is the trigger weight. In each calculation, only the score of the determined button information 803 will be added with the trigger weight γ. When the score S^{F} of any button information 803 reaches the threshold k, the calculation period is ended. For example, refer to the following score calculation table:

TABLE 1
Score calculation table

| | Let α = 1, γ = 2, | |
|---|---|---|
| | the initial value of | Floor Score Total |
| | S⁷ and S⁸ is zero | Let k = 14 |
| Time t = 0, 8F is identified | Sₜ₌₀⁷: 0 * α = 0 | 7F: 0 |
| through FIG. 7 | Sₜ₌₀⁸: 0 * α + γ = 2 | 8F: 2 |
| Time t = 1, 8F is identified | Sₜ₌₁⁷: 0 * α = 0 | 7F: 0 |
| through FIG. 7 | Sₜ₌₁⁸: 2* α + γ = 4 | 8F: 4 |
| Time t = 2, 7F is identified | Sₜ₌₂⁷: 0* α + γ = 2 | 7F: 2 |
| through FIG. 7 | Sₜ₌₂⁸: 4* α = 4 | 8F: 4 |
| Time t = 3, 7F is identified | Sₜ₌₃⁷: 2* α + γ = 4 | 7F: 4 |
| through FIG. 7 | Sₜ₌₃⁸: 4* α = 4 | 8F: 4 |
| Time t = 4, 7F is identified | Sₜ₌₄⁷: 4* α + γ = 6 | 7F: 6 |
| through FIG. 7 | Sₜ₌₄⁸: 4* α = 4 | 8F: 4 |
| Time t = 5, 7F is identified | Sₜ₌₅⁷: 6* α + γ = 8 | 7F: 8 |
| through FIG. 7 | Sₜ₌₅⁸: 4* α = 4 | 8F: 4 |
| Time t = 6, 7F is identified | Sₜ₌₆⁷: 8* α + γ = 10 | 7F: 10 |
| through FIG. 7 | Sₜ₌₆⁸: 4* α = 4 | 8F: 4 |
| Time t = 7, 7F is identified | Sₜ₌₇⁷: 10* α + γ = 12 | 7F: 12 |
| through FIG. 7 | Sₜ₌₇⁸: 4* α = 4 | 8F: 4 |
| Time t = 8, 7F is identified | Sₜ₌₈⁷: 12* α + γ = 14 | 7F: 14 |
| through FIG. 7 | Sₜ₌₈⁸: 4* α = 4 | 8F: 4 |
| | | (Trigger the 7F |
| | | elevator, all floor |
| | | scores S^{F} is reset |
| | | to zero.) |
| . | . | . |
| . | . | . |
| . | . | . |

Under this configuration, the system module 207 does not need to update the latest N time-series data all the time, and the user can modify the weights in the formula as required; for example,

$$γ = \frac{1}{{z}_{n} - {z}_{o}}$$

means that when the tip coordinate is closer to the button, the button information 803 can obtain a higher score, thereby the button can be more efficiently triggered when the tip is rapidly approaching the button. It should be noted that the weights and thresholds mentioned above are all exemplary descriptions, and the present invention is not limited thereto.

At block S110, the method includes receiving a control signal by the controller 209 and performing a control operation according to the control signal. As shown in FIG. 1, the controller 209 is electrically coupled to the buttons 201 and the system module 207. When triggering the buttons in a conventional contact method, the controller 209 receives a control signal generated by a certain button 201 being pressed, and then performs control operations on the elevator (such as going to a specific floor, opening doors, closing doors, etc.). In the present embodiment, the system module 207 generates the control signal in the processes mentioned above, while in the conventional contact method, the control signal can only be generated by pressing the button 201. After the controller 209 receives the control signal, it will execute the control operation on the elevator as if the button 201 were pressed.

With this configuration, in this embodiment, before the user's finger or the item held by the user touches the button 201, the sensor 205 will sense images, and the system module will determine the button that the user wants to press, to generate the control signal for the elevator in advance, which can achieve the purpose of the non-contact triggering elevator buttons without changing the user's operating habits.

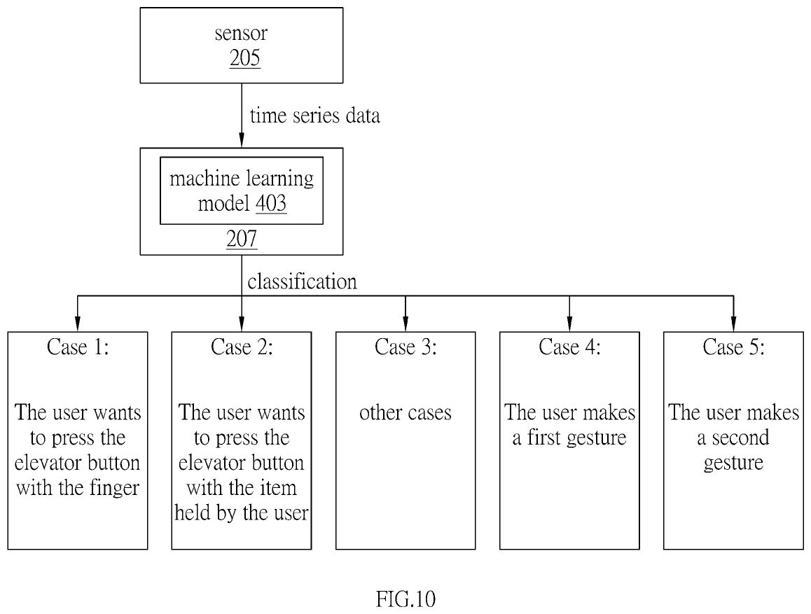

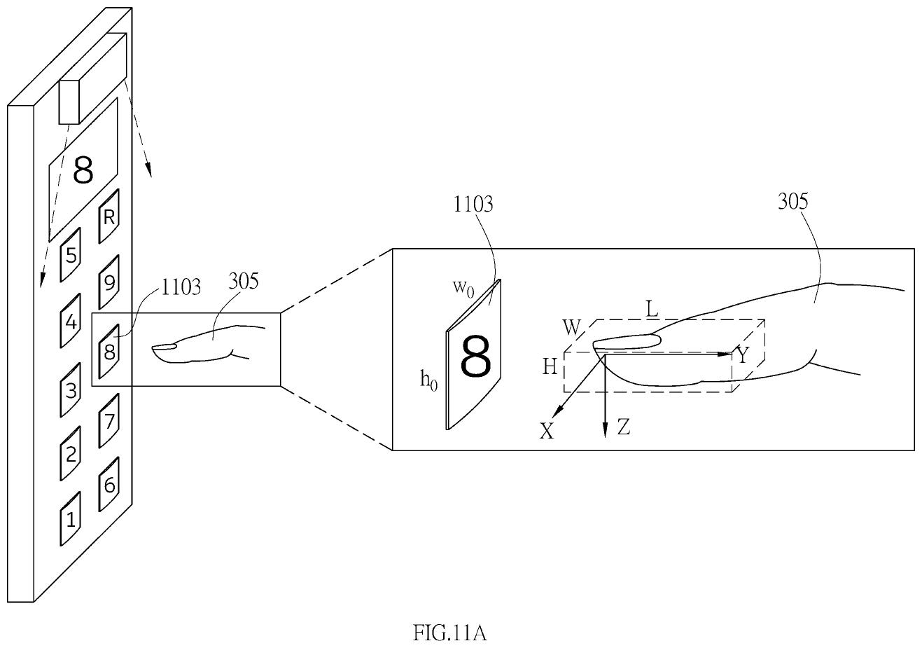

Referring to FIG. 9 and FIG. 10, another embodiment of the method for non-contact triggering of buttons S900 of the present invention is illustrated. In this embodiment, the method further includes a first mode for registering the button information 803. At block S902, the method includes identifying, by the system module 207, whether the target object is a hand and whether it is a first gesture or a second gesture. Referring to FIG. 10, in this embodiment, after the machine learning model 403 receives the time-series data, in addition to the classification of the three cases mentioned above (case 1 is that the user presses the elevator button with his finger, case 2 is that the user presses the elevator button with the hand-held item, and case 3 for other cases), there are cases 4 and 5. Case 4 is that the user makes a first gesture, and case 5 is that the user makes a second gesture. The first gesture and the second gesture can be specific default gestures (for example, the thumb and the index finger stretched out (i.e., the gesture indicating the number 7)), or can be any gesture set by the user. The present invention does not limit this. In addition, identifying gestures with machine learning technology is well known to those skilled in the art, the embodiment may be implemented in any appropriate way (for example, referring to FIG. 6, the gesture is determined as the number 7 by identifying the knuckles of the thumb and index finger). The present invention does not limit this.

Referring to FIG. 9, another embodiment of the method for non-contact triggering of buttons S900 of the present invention is continued. At block S904, the method further includes, when the system module 207 identified that the target object is the hand and is the first gesture, enabling the first mode. According to the identification result at block S902, the system module 207 will execute different processes. When the classification result is case 1 or case 2, block S106 shown in FIG. 1 will be continuously executed; that is, the system module 207 will determine the tip coordinates of tip 601 of the target object; when the classification result is case 3, the system module 207 does not execute a specific process and continues to receive time-series data from the sensor 205; when the classification result is case 4, the system module 207 enables the first mode, and the method is continued with block S906 which will be described below; when the classification result is case 5, the first mode is ended (refer to block S910 below for details).

At block S906, the system module 207 determines the gesture tip coordinates of the gesture tip of the first gesture. The determination method of the gesture tip can be performed in the same way as determining the tip 601 of the target object as illustrated in FIG. 6, and the determination method of gesture tip coordinates can also be performed in the same way as the determination of the tip coordinates of the target object illustrated in FIG. 6.

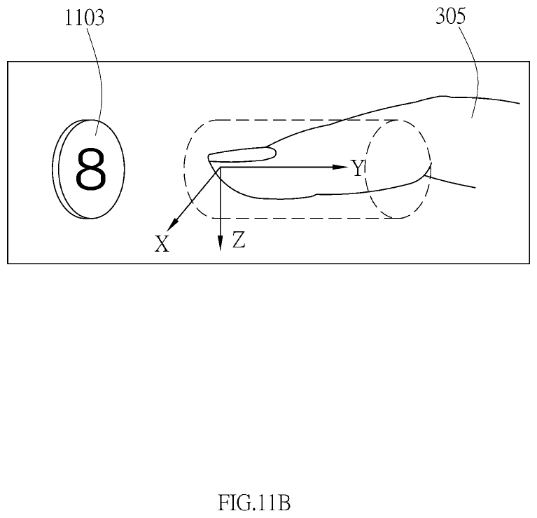

Referring to FIG. 11A, at block S908, the system module 207 calculates a first threshold range according to the gesture tip coordinates and associates the first threshold range with the first button 1103 to generate the first button information of the plurality of button information 803. In this embodiment, while the system module 207 is performing block S908, the user can press the first button 1103 (shown as 8F in this embodiment) with the first gesture, and then the controller 209 will receive the control signal associated with the first button 1103. The control signal is received and recorded by the system module 207 through the electrical connection between the controller 209 and the system module 207. At the same time, at block S908, the system module 207 calculates the first threshold range, and according to the control signal associated with the first button 1103, the system module 207 can record the first threshold range in a manner of corresponding to the first button 1103, thereby generating the first button information.

In this embodiment, the user presses the first button 1103 (8F) to generate a control signal associated with 8F, so that the system module 207 can store the first threshold range in a manner associated with 8F, and thereby the first button information is generated. However, in different embodiments, the user can actually not press the first button 1103, but the system module records the first threshold range one by one by the sequence of buttons, such as the first recorded threshold range corresponding to 1F, the second recorded threshold range corresponding to 2F, the third recorded threshold range corresponding to 3F, and so on. In addition, the user can also directly enter the system module 207 to make modifications in the background system and then record these threshold ranges in a manner associated with the corresponding floors. The above embodiments are only exemplary illustrations, and those skilled in the art can associate the first threshold range with the first button in any appropriate manner; the present invention does not limit this.

Referring to the box shown by the dotted line in FIG. 11A, the first threshold range indicates a virtual space in front of the first button 1103. When the target object falls within the virtual space (that is, its tip coordinate is within the first threshold range), the system module 207 will determine that the user intends to press the first button 1103 (referring to block S108 mentioned above). Therefore, the size of the virtual space will affect the accuracy of the method in determining the user's intention.

In this embodiment, the range of the width (W) of the space is the X-axis coordinate Xₕ of the gesture tip coordinate plus/minus half of the width W₀ of the button 201 (W₀/2); that is, the X-axis range of the first threshold range is

$${X}_{h} \pm \frac{{W}_{0}}{2} .$$

The range of the height (H) of the space is the Z-axis coordinate Zₕ of the gesture tip coordinate plus/minus half of the height H₀ of the button 201 (H₀/2); that is, the Z-axis range of the first threshold range is

$${Z}_{h} \pm \frac{{H}_{0}}{2} .$$

In addition, since the range of the length (L) of the space is not necessarily related to the Y-axis coordinate of the gesture tip coordinate, it is directly set to 0-0.02 m in this embodiment. For example, if the gesture tip coordinates are determined to be (0.045, 0.01, 0.67), the first button is 8F, and the width and height of the button is both 4 cm, the first threshold range should be (0.025-0.065, 0.00-0.02, 0.65-0.69), and in response to the control signal associated with the first button 1103 (8F) received by the system module 207, the first threshold range will be associated with the first button 1103, thereby generating first button information (see button information 803a in FIG. 8A). After all the buttons 201 are registered, a lookup table as shown in FIG. 8A will be generated.

It should be noted that the numerical values described herein are all exemplary, and those skilled in the art can determine the first threshold range in other ways. The present invention does not limit this. In addition, although the button 201 is shown as a rectangle in this embodiment, in different embodiments, the button 201 can be a circle or other shapes, and the first threshold range can be a space of a cylinder (referring to the circular column shown by the dotted line in FIG. 11B) or other columns according to different shapes of the button 201, which is not limited in the present invention.

At block S910, the method includes ending the first mode when the system module 207 identified that the target object is the hand and is the second gesture. After the first mode is ended, the method S900 of registering the buttons 201 will not be executed when the target object approaches the operation panel 203, but the processes shown in the method S100 in FIG. 1 will be executed. With this configuration, the user can register the button information 803 for the buttons 201, to generate the lookup table as shown in FIG. 8A. In this way, even if the arrangement or relative positions of the buttons 201 in different elevators are different, the user can register the button information 803 one by one through the first mode, to simply apply the present invention to different elevators and update the button information 803 at any time to ensure its accuracy.

The following illustrates another embodiment of the method for non-contact triggering of buttons of the present invention. This embodiment further includes enabling or disabling the first mode through the registration interface connected to the system module 207 by a wired or wireless connection, instead of enabling/disabling the first mode by identifying the first gesture/second gesture. The registration interface can be a user interface on any operating device (such as a mobile phone, a notebook, etc.), and the operating device can be connected to the system module 207 by a wired or wireless (such as Bluetooth) connection, thereby transmitting signals to control the system module 207 to enable or disable the first mode. In addition, the registration interface may also include options corresponding to different buttons 201. When the system module 207 executes block S908, the user can simultaneously use the registration interface to select the first button 1103 corresponding to the first threshold range, thereby recording the first threshold range in a manner associated with the floor to generate the first button information. For example, after determining the first threshold range, the user can simultaneously select the eighth floor (8F) on the registration interface, so that the system module 207 can associate the determined first threshold range with 8F, and record it in the lookup table as shown in FIG. 8A.

The following illustrates another embodiment of the method for non-contact triggering of buttons of the present invention. The difference between this embodiment and the others is that the machine learning model 403 determines the tip coordinates of the first item after identifying the first item, then it calculates the first threshold range of the tip coordinates of the first object when the system module 207 determined that the images 300 contains a second object (which may be an item different from the first item, or a specific gesture, etc., which is not limited in the present invention), and after performing the above-mentioned block S908, the registration is directly ended. The first item may be a default specific item, such as a cylindrical long-shaped item, or an item marked with color, etc. The present invention does not limit this. By providing a training set, the machine learning model 403 can be trained so that the machine learning model 403 can identify the first item and the second object, thereby completing this embodiment. In addition, in different embodiments, the second object may not be included, and the registration process can be started through the registration interface connected to the system module 207 by a wired or wireless connection, instead of identifying the second object. For example, when the system module 207 determines the first tip coordinates of the first item, the user can select an option (for example, “register this coordinate”) on the registration interface, and then a signal is transmitted to the system module 207, so that the system module 207 determines the first threshold range according to the first tip coordinate, and then records the button information 803.

Another embodiment of the present invention provides a non-contact elevator buttons triggering device for executing the method for non-contact triggering of elevator buttons in the above-mentioned embodiments. Referring to FIG. 2, the device includes a plurality of buttons 201 arranged on the operation panel 203, a sensor 205 arranged on the operation panel 203 at a position higher than the buttons 201 (wherein the sensor is electrically coupled to the system module 207), the system module 207 electrically connected to the controller 209, and the controller 209 electrically connected to both the buttons 201 and the system module 207. In this embodiment, the sensor 205 is a 3D sensor (e.g., a 3D camera). Referring to FIG. 1, the sensor performs block S102, the system module 207 performs blocks S104-S106 and the method S900, and the controller performs block S110. It should be noted that although the sensor 205 is arranged at a position higher than the buttons 201 in this embodiment, in different embodiments, the sensor can be arranged at any suitable (the sensing range should cover all the buttons) position (e.g., below the buttons 201), which is not limited in the present invention.

The above disclosure is only a preferred embodiment of the present invention and is not intended to limit the scope of the claims of the present invention. The sequence of the method described herein is only an exemplary illustration, and those ordinary skilled in the art can modify the sequence of the processes under the equivalent concept of the present invention. In addition, unless there is a clear contradiction with the context, the singular terms “a” and “the” used in this content also includes plural situation, and the terms “first” and “second” are also intended to make those ordinary skilled in the art can easily understand the concept of the content of the present invention, but do not intend to limit the nature of the elements in the present invention. The shapes, positions, and sizes of each element, component, and unit in the accompanying drawings are intended to illustrate the technical content of the present invention concisely and clearly, rather than limiting the present invention. Also, the well-known details or constructions will be omitted from the drawings.

What is claimed is:

1. A non-contact button triggering method, comprising:
sensing time series data with a sensor arranged on an operation panel, wherein the time series data includes at least one image, and a range of the image covers a plurality of buttons arranged on the operation panel;
determining whether the image contains a target object by a system module;
determining tip coordinate of a tip of the target object by the system module when the image contains the target object, wherein the tip refers to a point of the target object with the closest distance to the operation panel;
determining button information corresponding to the tip coordinate among a plurality of button information by the system module, and transmitting a control signal at least according to the button information, wherein the plurality of button information is associated with the plurality of buttons; and
receiving the control signal by a controller, and performing control operation according to the control signal.

2. The method of claim 1, wherein determining whether the image contains the target object comprises:
identifying an object in the image by the system module to generate a classification result; and
determining whether the object is the target object according to the classification result.

3. The method of claim 2, wherein determining whether the image contains the target object comprises inputting the time series data into a machine learning model for determination.

4. The method of claim 1, wherein transmitting the control signal at least according to the button information further comprises:
determining a score of the button information corresponding to the tip coordinate by the system module, and transmitting the control signal according to the button information only when the score is the highest score, reaches a threshold, or both within a calculation period.

5. The method of claim 1, further comprising registering the button information, which comprises:
identifying whether the target object is a hand and whether it is a first gesture or a second gesture by the system module;
enabling a first mode when the system module identified that the target object is the hand and is the first gesture;
determining a gesture tip coordinate of a gesture tip of the first gesture by the system module;
calculating a first threshold range according to the gesture tip coordinate, and associating the first threshold range with a first button to generate first button information of the plurality of button information; and
disabling the first mode when the system module identified that the target object is the hand and is the second gesture.

6. The method of claim 5, wherein determining the button information corresponding to the tip coordinate among the plurality of button information comprises:
determining that the tip coordinate corresponds to the first button information when the tip coordinate is within the first threshold range.

7. The method of claim 1, further comprising registering the button information, which comprises:
enabling a first mode through a registration interface connected to the system module by wired or wireless connection;
determining a first tip coordinate of the target object by the system module;
calculating a first threshold range according to the first tip coordinate, and associating the first threshold range with a first button to generate first button information of the plurality of button information; and
disabling the first mode through the registration interface.

8. The method of claim 1, further comprising registering the button information, which comprises:
identifying whether the target object includes a first item or a second object by the system module;
determining a first tip coordinate of the first item by the system module when the system module identified that the target object includes the first item;
enabling a third mode when the system module identified that the target object includes the second object; and
calculating a first threshold range according to the first tip coordinate, associating the first threshold range with a first button by the system module to generate first button information of the plurality of button information, and disabling the third mode.

9. The method of claim 1, further comprising registering the button information, which comprises:
identifying whether the target object includes a first item by the system module;
determining a first tip coordinate of the first item by the system module when the system module identified that the target object includes the first item;
enabling a third mode through a registration interface connected to the system module by wired or wireless connection; and
calculating a first threshold range according to the first tip coordinate, associating the first threshold range with a first button by the system module to generate first button information of the plurality of button information, and disabling the third mode.

10. The method of claim 1, wherein determining the tip coordinate of the tip of the target object comprises:
identifying a plurality of protruding points of the target object by the system module, and determining one of the plurality of protruding points with the closest distance to the operation panel to be the tip.

11. The method of claim 1, wherein the sensor is a 3D sensor, and the time series data includes the image and depth information.

12. The method of claim 1, wherein the sensor is arranged above the plurality of buttons, and the range of the image does not cover a user's face.

13. A non-contact button triggering device, comprising:
a sensor adapted to sense time series data, wherein the time series data includes at least one image, and a range of the image covers a plurality of buttons arranged on an operation panel;
a system module configured to:
determine whether the image contains a target object;
determine a tip coordinate of a tip of the target object when the image contains the target object, wherein the tip refers to a point of the target object with the closest distance to the operation panel;
determine button information corresponding to the tip coordinate among a plurality of button information, and transmit a control signal at least according to the button information, wherein the plurality of button information is associated with the plurality of buttons; and
a controller adapted to receive the control signal and perform control operation according to the control signal.

14. The device of claim 13, wherein the system module configured to determine whether the image contains the target object comprises:
identifying an object in the image to generate a classification result; and
determining whether the object is the target object according to the classification result.

15. The device of claim 14, wherein the system module configured to determine whether the image contains the target object comprises inputting the time series data into a machine learning model for determination.

16. The device of claim 13, wherein the system module configured to transmit the control signal at least according to the button information comprises:
determining a score of the button information corresponding to the tip coordinate, and transmitting the control signal according to the button information only when the score is the highest score, reaches a threshold, or both within a calculation period.

17. The device of claim 13, wherein, in order to register the button information, the system module is further configured to:
identify whether the target object is a hand and whether it is a first gesture or a second gesture;
enable a first mode when the target object is the hand and is the first gesture;
determine a gesture tip coordinate of a gesture tip of the first gesture;
calculate a first threshold range according to the gesture tip coordinate, and associate the first threshold range with a first button to generate first button information of the plurality of button information; and
disable the first mode when the target object is the hand and is the second gesture.

18. The device of claim 17, wherein the system module configured to determine the button information of the plurality of button information corresponding to the tip coordinate comprises:
determining that the tip coordinate corresponds to the first button information when the tip coordinate is within the first threshold range.

19. The device of claim 13, further comprising a registration interface adapted to enable or disable a first mode, wherein the registration interface is connected to the system module by wired or wireless connection, and when the first mode is enabled, in order to register the button information, the system module is configured to
determine a first tip coordinate of the target object; and
calculate a first threshold range according to the first tip coordinate, and associate the first threshold range with a first button to generate first button information of the plurality of button information.

20. The device of claim 13, wherein, in order to register the button information, the system module is further configured to:
identify whether the target object includes a first item or a second object;
determine a first tip coordinate of the first item when the target object includes the first item;
enable a third mode when the target object includes the second object; and
calculate a first threshold range according to the first tip coordinate, associate the first threshold range with a first button to generate first button information of the plurality of button information, and disable the third mode.

21. The device of claim 13, further comprising a registration interface connected to the system module by wired or wireless connection, wherein, in order to register the button information, the system module is further configured to:
identify whether the target object includes a first item;
determine a first tip coordinate of the first item when the target object includes the first item;
enable a third mode in response to an operation on the registration interface; and
calculate a first threshold range according to the first tip coordinate, associate the first threshold range with a first button to generate first button information of the plurality of button information, and disable the third mode.

22. The device of claim 13, wherein the system module configured to determine the tip coordinate of the tip of the target object comprises:
identifying a plurality of protruding points of the target object, and determining one of the plurality of protruding points with the closest distance to the operation panel to be the tip.

23. The device of claim 13, wherein the sensor is a 3D sensor, and the time series data includes the image and depth information.

24. The device of claim 13, wherein the sensor is arranged above the plurality of buttons, and the range of the image does not cover a user's face.
